(19) United States
(12) Patent Application Publication
(10) Pub. No.: US 2008/0266194 A1
(43) Pub. Date: Oct. 30, 2008

(54) Slot Antenna with a Spiral Feed Element for Wireless Communication Devices

(75) Inventor: Minh-Chau T. Huynh, Morrisville, NC (US)

Correspondence Address: COATS & BENNETT/SONY ERICSSON, 1400 CRESCENT GREEN, SUITE 300, CARY, NC, 27511, US

(73) Assignee: Sony Ericsson Mobile Communications AB, Lund (SE)

(21) Appl. No.: 11/741,450

(22) Filed: Apr. 27, 2007

(51) Int. Cl. H01Q 13/10; H01P 11/00

(52) U.S. Cl. 343/767; 29/600

(57) ABSTRACT

A slot antenna for short-range communications between wireless communication devices is described herein. The antenna comprises a radiating plate spaced from a ground plate. A slot in the radiating plate defines the resonant frequency of the antenna. A spiral feed element disposed beneath the slot and between the ground plate and the radiating plate feeds transmission signals to the antenna. The slot antenna may be used in any portable wireless communication device configured to transmit short-range wireless signals, such as Bluetooth® signals.

### BACKGROUND

The present invention relates generally to antennas for wireless communication devices, and more particularly to antennas for short-range wireless communications between wireless communication devices.

The continuing trend with wireless communication devices is to reduce the size of the wireless communication device. However, smaller devices often present design challenges for the device electronics, particularly the antenna. For example, as the device size decreases, the space available for an antenna also decreases. Thus, conventional antennas may not fit within smaller wireless communication devices. In addition, as the thickness of a wireless communication device decreases, the mechanical rigidity of these devices must increase to provide sufficient support for the device. Manufacturers may use a metal frame to increase the mechanical rigidity of the housing. However, metal frames often degrade the performance of the antennas conventionally used in wireless communication devices.

### SUMMARY

The present invention comprises a slot antenna for a wireless communication device. The antenna comprises a radiating plate spaced from a ground plate. The radiating plate includes a slot that helps define the resonant frequency of the antenna. A spiral feed element disposed beneath the slot and between the ground plate and the radiating plate provides the transmission signal to the antenna. In one embodiment, the slot antenna may be used in a portable wireless communication device configured to transmit short-range wireless signals, such as Bluetooth® signals.

### BRIEF DESCRIPTION OF THE DRAWINGS

FIG. 1 shows a block diagram of a wireless communication device.

FIGS. 2A-2C show a slot antenna according to one embodiment of the present invention.

FIGS. 3A and 3B show a top and cross-sectional view of the slot antenna of FIG. 2A.

FIGS. 4A and 4B show examples of continuous spirals.

FIGS. 5A and 5B show examples of step spirals.

FIG. 6 show test results for the slot antenna of FIG. 2A.

FIG. 7 shows one embodiment for the slot antenna relative to the housing for the wireless communication device.

FIG. 8 shows another embodiment for the slot antenna relative to the housing for the wireless communication device.

FIG. 9 shows one example of a three-dimensional spiral element

### DETAILED DESCRIPTION

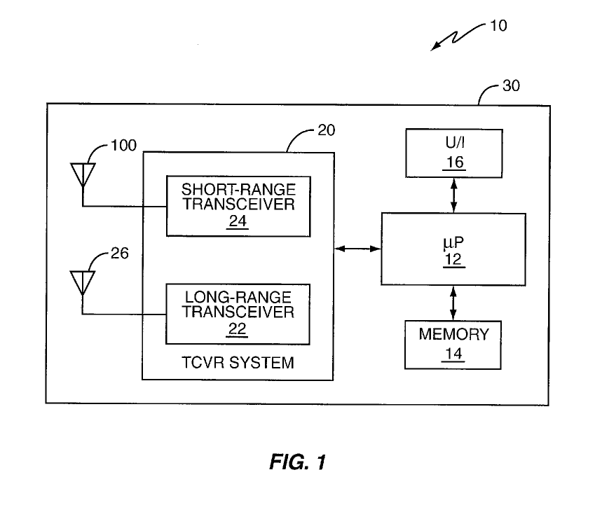

FIG. 1 illustrates an exemplary wireless communication device 10 that uses a slot antenna 100 to transmit and receive wireless signals in high frequency bands. The wireless communication device 10 may comprise any wireless communication device. Exemplary wireless communication devices 10 include but are not limited to, cellular telephones, portable data assistants, pagers, palmtop computers, etc.

Wireless communication device 10 includes a controller 12, memory 14, user interface 16, and transceiver system 20 disposed in a housing 30. Controller 12 controls the operation of the device 10 responsive to programs stored in memory 14 and instructions provided by the user via user interface 16. Transceiver system 20 includes multiple transceivers 22, 24 that communicate wireless speech and data signals. The long-range transceiver 22 communicates signals to and from a base station in a wireless communications network (not shown) via antenna 26. Transceiver 22 may be a fully functional cellular radio transceiver that operates according to any known standard, including the standards known generally as GSM, TIA/EIA-136, cdmaOne, cdma2000, UMTS, UNII, and Wideband CDMA. The short-range transceiver 24 communicates signals with another local wireless communication device over a short distance using an unregulated frequency band, e.g., the 2.4 GHz Bluetooth® frequency band, via antenna 100. Transceiver 24 comprises a fully functional short-range transceiver that operates according to any known short-range standard, including but not limited to wireless local area network (WLAN) standards and ad hoc standards, e.g., Bluetooth®.

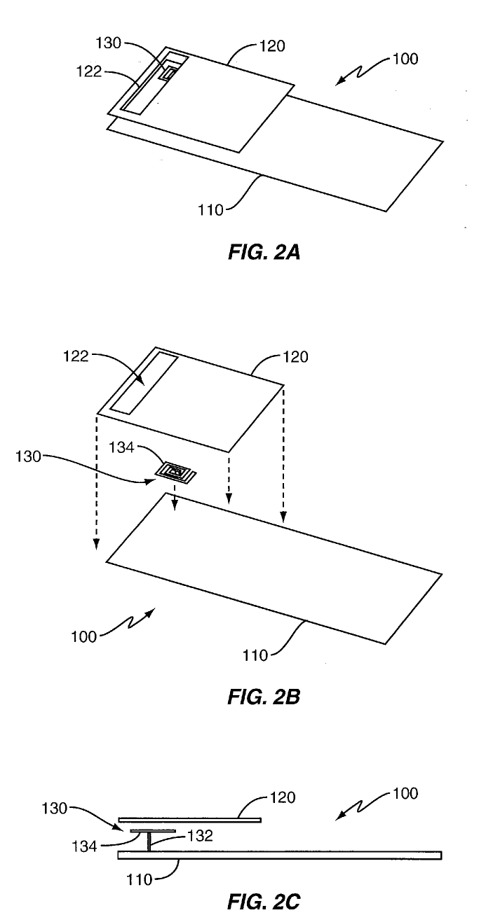

FIGS. 2A-2C show different views of one exemplary slot antenna 100. FIG. 2A shows a perspective view of an assembled slot antenna 100. FIG. 2B shows an exploded view of the antenna 100 in FIG. 2A, while FIG. 2C shows a cross-sectional view of the antenna 100 in FIG. 2A. It will be appreciated that this configuration is illustrative and not limiting.

Antenna 100 includes a ground plate 110, radiating plate 120, and spiral feed element 130. Radiating plate 120 includes a slot 122 and is spaced from the ground plate 110 by a predetermined distance and overlaps at least a portion of the ground plate 110. As shown in FIGS. 2A-2C, slot 122 may comprise a linear slot disposed through the radiating plate 120 and transverse to a longitudinal axis of the ground plate 110 at one end of the radiating plate 120. Spiral feed element 130 connects to an antenna feed 132 that provides a transmission signal to the antenna 100. The spiral feed element 130 is disposed between the ground plate 110 and radiating plate 120 beneath the slot 122. As discussed further below, the location of the spiral feed element 130 relative to the slot 122 helps define the antenna input impedance. As shown in FIGS. 2A and 2B, the spiral feed element 130 may be longitudinally offset relative to a center of the slot 122. In one embodiment, the spiral feed element 130 is disposed beneath and proximate one longitudinal end of the slot 122.

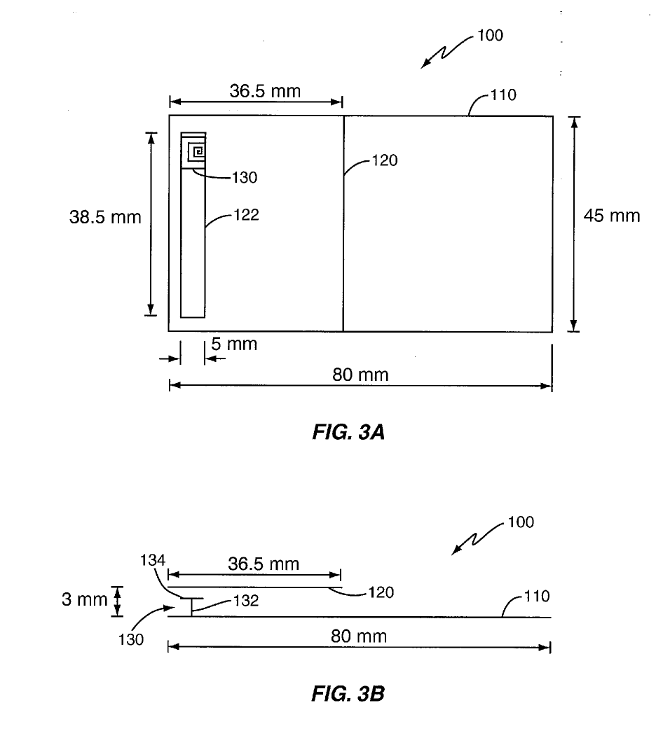

The size, relative orientation, and shape of the antenna elements 110-130 control operating parameters of the antenna 100. Exemplary parameters include, but are not limited to, impedance, resonant frequency, polarization, feeding system inductance, and feeding system capacitance. The following describes the size, relative orientation, and shape of each antenna element 110-130. To facilitate this discussion, FIGS. 3A and 3B show the dimensions of the antenna elements 110-130 for one exemplary slot antenna 100. It will be appreciated that the antenna 100 of the present invention is not limited to the dimensions or configuration shown in FIGS. 3A and 3B.

Ground plate 110 comprises a conductive plate having a generally rectangular shape. In one embodiment, the ground plate 110 is made of conductive metal, e.g., copper. For a rigid and/or lightweight ground plate 110, the ground plate 110 may be made from magnesium. The ground plate 110 has finite dimensions that help control the antenna impedance as well as the amount of back radiation. Because the ground plate 110 is typically the largest element of the antenna 100, the size of the wireless communication device 10 often limits the size of the ground plate 110. In one exemplary embodiment, the dimensions for the ground plate 110 may be 45 mm wide and 80 mm long to enable the antenna 100 to fit within a wireless communication device 10 that is 45 mm wide and 90 mm long.

The radiating plate 120 is spaced from the ground plate 110 and comprises a conductive plate having a generally rectangular shape and a slot 122 disposed through the conductive plate. In one embodiment, the radiating plate 120 is made of conductive metal, e.g., copper, and is spaced at least 3 mm from the ground plate 110. Current induced by capacitive coupling between the spiral feed element 130 and the radiating plate 120 flows on the radiating plate 120 around the slot 122, where electric fields flow along the direction of the slot's minor axis and magnetic fields flow along the direction of the slot's major (longitudinal) axis. The dimensions of the radiating plate 120 help control the resonance frequency and impedance of the antenna 100.

The slot 122 provides the main radiation mechanism for the antenna 100, where the length of the slot 122 primarily controls the resonance frequency of the antenna 100. The longitudinal length of the slot 122 in one exemplary embodiment is approximately 0.3λ. If the radiating plate 120 is infinitely large relative to the slot 122, antenna 100 behaves like a dipole antenna. However, the radiating plate 120 in practice has finite dimensions relative to the slot, e.g., 45 mm wide and 36.5 mm long. Thus, the exemplary slot antenna 100 in FIGS. 3A and 3B represents a ˜0.3λ antenna.

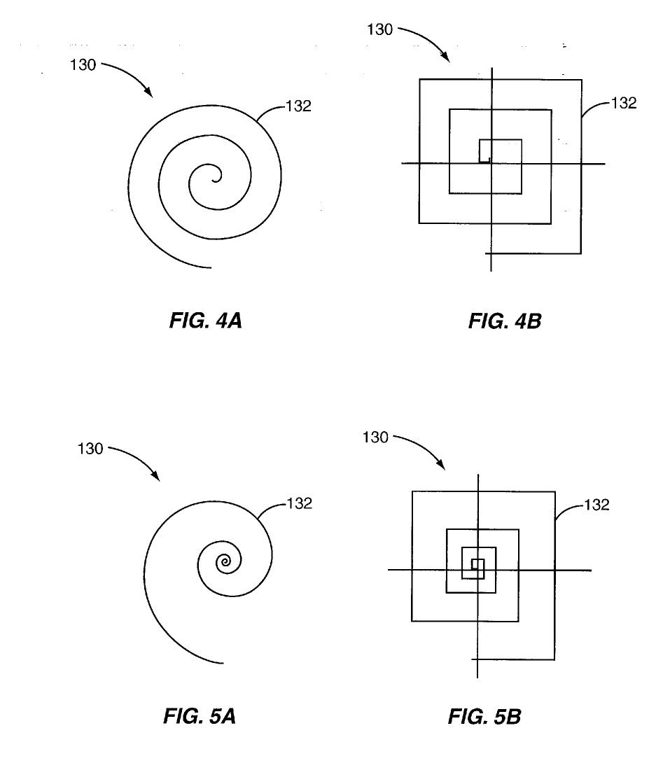

The spiral feed element 130 comprises a conductive element 134 wound around a central point with a monotonically increasing distance. Spiral feed element 130 may comprise any spiral or coil shape, including but not limited to, a continuously curving or step-wise increasing spiral, e.g., a circular, square, triangular, or pentagonal spiral. For example, the spiral feed element 130 may comprise an Archimedean spiral having a continuously increasing radius, as shown in FIG. 4A, or a step-wise increasing radius, as shown in FIG. 4B. Alternatively, the spiral feed element 130 may comprise a longitudinal spiral having a continuously increasing radius, as shown in FIG. 5A, or a step-wise increasing radius, as shown in FIG. 5B. In any event, the length of the spiral feed element 130 helps control the resonant frequency of the antenna 100. In addition, the length of the spiral feed element 130, the distance between the spiral feed element 130 and the radiating plate 120, the location of the spiral feed element 130 relative to the center of the slot 122, the thickness of the conductive element 134, and the overall width of the spiral feed element 130 help control the input impedance of the antenna 100. For example, the antenna input impedance decreases as the spiral feed element 130 moves away from the center of the slot 122 towards one longitudinal end of the slot 122. Further, the capacitance and resistance of the antenna increases as the thickness of conductive element 132 increases and/or as the overall width of the spiral element 130 increases. In one embodiment, the antenna input impedance may be matched to 50Ω when spiral feed element 130 has a coil separation of 1 mm, an overall width of 1 mm, and is disposed beneath one longitudinal end of the slot 122 by 1 mm.

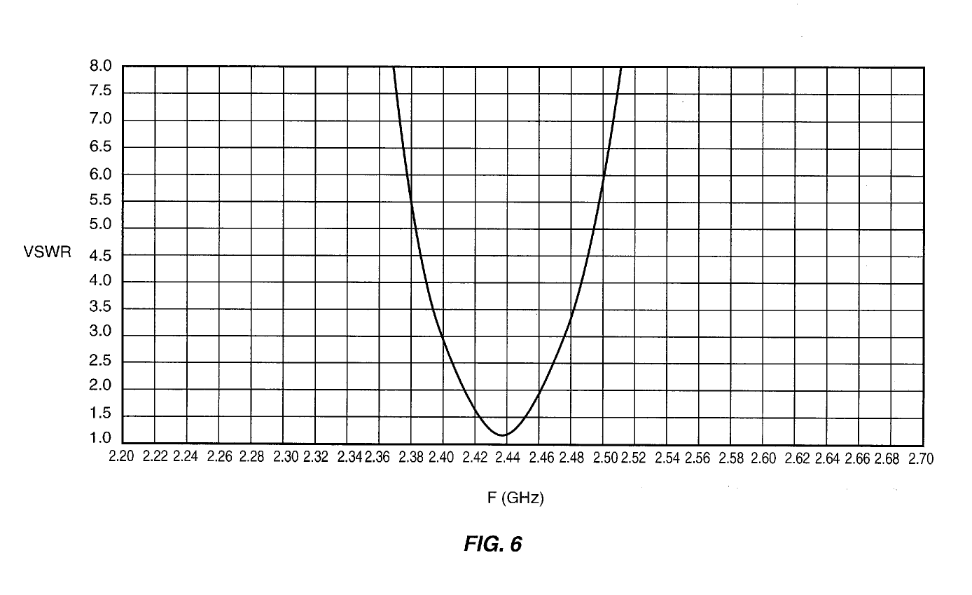

FIG. 6 shows test results that illustrate the Voltage Standing Wave Ratio (VSWR) for the antenna shown in FIGS. 1-3. As shown in FIG. 6, the VSWR is less than 2 for frequencies between 2.41 GHz and 2.46 GHz, and is less than 1.5 for frequencies between 2.42 GHz and 2.45 GHz. Thus, the slot antenna 100 described above provides excellent performance in the 2.4 GHz frequency band.

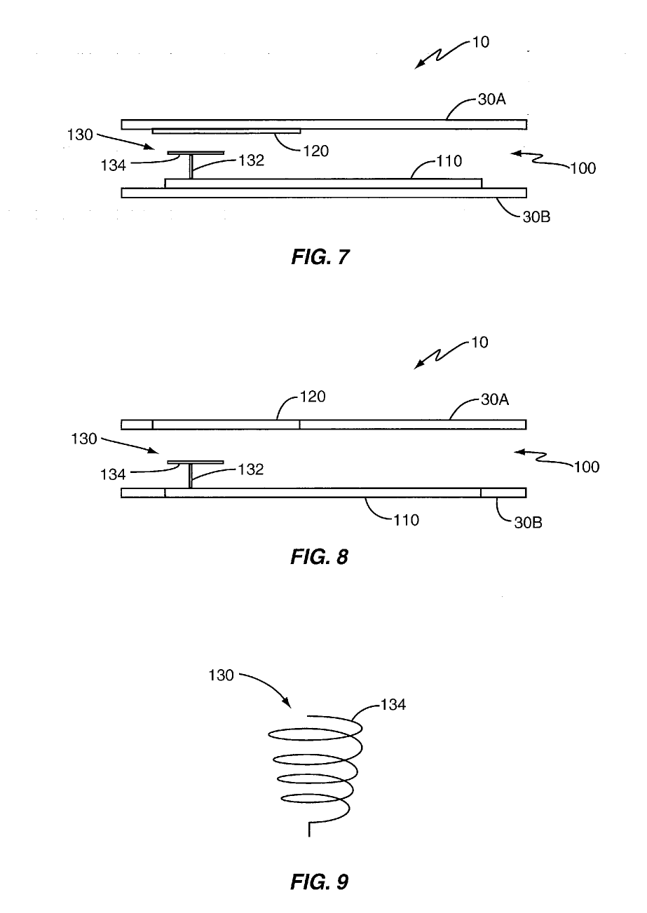

In one embodiment, the antenna 100 and housing 30 may also collectively provide structural support for the wireless communication device 10, as shown in FIGS. 7 and 8. For example, the housing 30 may comprise a plastic cover 30A and a metal frame 30B. The metal frame 30B may include side walls (not shown) disposed proximate the ground plate 110 and radiating plate 120. While the side walls may contact the ground plate 110, they generally do not contact the radiating plate 120. In the embodiment in FIG. 7, a conductive material, e.g., copper tape, forms the radiating plate 120 and slot 122 on the underside of the plastic cover 30A. The ground plate 110 may be electrically isolated from the metal frame 30B by a dielectric, or may alternatively be secured to the metal frame 30B. For the latter, the metal frame 30B extends the length of the ground plate 110, and thus acts as an extension of the ground plate 110. In the embodiment shown in FIG. 8, the ground plate 110 and the radiating plate 120 form a portion of the housing 30. In this embodiment, the ground plate 110 forms a part of the metal frame 30B of the housing 30. Further, the radiating plate 120 is disposed between sections of the plastic cover 30A. While not explicitly shown, it will be appreciated that the antenna 100 may be constructed according to some combination of FIGS. 7 and 8. For example, the radiating plate 120 may be constructed with conductive tape secured to the underside of the plastic cover 30A, as shown in FIG. 7, while the ground plate 110 may form a part of the metal frame 30B, as shown in FIG. 8.

The embodiments described above are intended to illustrate the basic principles of the invention. Those skilled in the art will recognize that these principles may be applied in numerous alternative embodiments. For example, the spiral feed element 130 may comprise a three-dimensional spiral feed element 130, as shown in FIG. 9, the spiral feed element 130 may be non-parallel to the radiating plate 120, the slot 122 may be non-linear, and/or the slot 122 may be non-perpendicular to the longitudinal axis of the ground plate 110.

The above describes antenna 100 as a short-range communications antenna operating in a 2.4 GHz frequency band. However, it will be appreciated that the antenna 100 may be tuned to operate in any higher frequency band, e.g., a WLAN frequency band. Further, if the size of the wireless communication device 10 increases sufficiently, the antenna 100 may be tuned to operate in a lower frequency band suitable for long-range communications.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A slot antenna for a wireless communication device comprising:
a ground plate;
a radiating plate spaced from the ground plate and overlapping at least a portion of the ground plate;
a slot disposed in the radiating plate; and
a spiral feed element disposed beneath the slot and between the ground plate and the radiating plate.

2. The slot antenna of claim 1 wherein the spiral feed element is longitudinally offset relative to a center of the slot.

3. The slot antenna of claim 1 wherein the spiral feed element is disposed beneath the slot proximate a longitudinal end of the slot.

4. The slot antenna of claim 1 wherein at least one of the ground plate and the radiating plate form a portion of a housing of the wireless communication device.

5. The slot antenna of claim 1 wherein the slot comprises a linear slot disposed transverse to a longitudinal axis of the ground plate.

6. The slot antenna of claim 1 wherein the slot is disposed proximate a first longitudinal end of the radiating plate, and wherein the first longitudinal end of the radiating plate is disposed proximate one longitudinal end of the ground plate.

7. The slot antenna of claim 1 wherein the spiral feed element comprises one of a planar spiral feed element and a three-dimensional spiral feed element.

8. The slot antenna of claim 1 wherein the spiral feed element has one of a continuously increasing radius and a step-wise increasing radius.

9. The slot antenna of claim 1 wherein the slot antenna is disposed in a cellular telephone.

10. The slot antenna of claim 1 wherein the slot antenna radiates in a 2.4 GHz frequency band.

11. A method of constructing a slot antenna for a wireless communication device comprising:
spacing a radiating plate from a ground plate such that the radiating plate overlaps at least a portion of the ground plate;
forming a slot in the radiating plate; and
disposing a spiral feed element beneath the slot and between the ground plate and the radiating plate.

12. The method of claim 11 wherein disposing the spiral feed element comprises disposing the spiral feed element beneath the slot and longitudinally offset relative to a center of the slot.

13. The method of claim 1 wherein disposing the spiral feed element comprises disposing the spiral feed element beneath the slot and proximate a longitudinal end of the slot.

14. The method of claim 11 further comprising forming at least a portion of a housing of the wireless communication device from at least one of the ground plate and the radiating plate.

15. The method of claim 11 wherein forming the slot comprises forming a linear slot transverse to a longitudinal axis of the ground plate.

16. The method of claim 11 wherein forming the slot comprises:
forming the slot proximate a first longitudinal end of the radiating plate; and
disposing the first longitudinal end of the radiating plate proximate one longitudinal end of the ground plate.
